(19) United States
(12) Patent Application Publication
(10) Pub. No.: US 2020/0026787 A1
(43) Pub. Date: Jan. 23, 2020

(54) METHOD, SYSTEM, AND FRAMEWORK FOR IMPLEMENTING INTERNET OF THINGS (IoT) APPLICATIONS

(71) Applicant: Wipro Limited, Bangalore (IN)

(72) Inventor: Mohammed Intisam Alam, Bangalore (IN)

(21) Appl. No.: 16/134,744

(22) Filed: Sep. 18, 2018

(30) Foreign Application Priority Data
Jul. 23, 2018 (IN) 201841027631

(51) Int. Cl. G06F 17/30; G06F 9/445; G06F 9/54

(52) U.S. Cl. CPC G06F 17/30377; G06F 9/542; G06F 9/44505

(57) ABSTRACT

This disclosure relates generally to Internet of Things (IoT), and more particularly to method, system, and framework for implementing IoT applications. In one embodiment, a method is provided for implementing a software application for an IoT device. The method may include defining, by an IoT implementation framework, a set of events and a set of actions for the IT implementation based on a process flow and configuration metadata. The method may further include creating, by the implementation framework, a set of custom actions, for the IT implementation, based on the set of events, the set of actions, and the configuration metadata. The method may further include processing, by the implementation framework, a set of messages received from the IoT device based on the process flow, the set of custom actions, and a set of pre-built actions.

This application claims the benefit of Indian Patent Application Serial No. 201841027631, filed Jul. 23, 2018, which is hereby incorporated by reference in its entirety.

### FIELD

This disclosure relates generally to Internet of Things (IoT), and more particularly to method, system, and framework for implementing IoT applications.

### BACKGROUND

The Internet of Things (IoT) is an emerging technology, combining various physical devices with the Internet to form a huge network. The physical devices may also be referred to as IoT devices and may include, but may not be limited to, wearable devices, vehicles, home appliances, and so forth. The physical devices are embedded with electronics, software applications, sensors, actuators, etc. so as to enable the physical devices to connect and exchange data. In fact, the IoT is recognized as an extension of today's Internet to the real world of physical objects, and is often associated with terms such as ‘ambient intelligence’, ‘ubiquitous network’, and ‘cyberphysical system’. With rapid development and adoption of communication technology and Internet technology, the penetration of IoT in today's world is increasing day by day. Various IoT platforms have been developed so as to allow quick and easy development, deployment and administration of IoT applications (i.e., software applications for IoT devices).

Typically, during development and implementation of the IoT applications, the developer may handle each step—from creation and storage to analysis and action of the data by handling numerous facets. The developer may also consider security aspects such as authentication and authorization. Thus, apart from managing the data, the IoT platform must allow IoT applications to be built that are specific to the customers' needs in rapid time. Additionally, each time when developers receive a requirement for any information technology (IT) implementation on IoT (e.g., any implementation of IoT application), they have to re-design and re-develop most of the component based on technology of the IoT platform. In most of the cases, for each of the interface, the developers have to re-develop the entire interface, which may result in a lot of redundancies and bug prone components. Further, such implementation needs more versatility in terms of skills and is time consuming. As each implementation is technology specific, each time the technology or the IoT platform changes, the code needs to be revisited according to the requirement. Since the developers develop the application or implementation as per their convenience there is no consistency or standardization. This may create major issues in terms of maintainability and supportability. Moreover, such implementation of IoT applications may require a lot of time and effort. As the industry is changing with a rapid pace, the speed of delivery has become very essential and important for any organization.

Some of the IoT application development systems provide for pre-stored re-useable artefacts for development of IoT application. Such platform may facilitate developers to develop IoT applications using the knowledge database, thereby maximizing the reuse of the artefacts and saving a lot of time and resources. However, even these systems do not take care of various other aspects of the IoT implementation. In particular, such systems fail to provide for a configurable, portable, platform independent and technology agnostic framework which can help the organization to adopt IoT faster with better quality.

### SUMMARY

In one embodiment, a method for implementing a software application for an Internet of things (IoT) device is disclosed. In one example, the method may include defining, by an IoT implementation framework, a set of events and a set of actions for the IT implementation based on a process flow and configuration metadata. The method may further include creating, by the implementation framework, a set of custom actions, for the IT implementation, based on the set of events, the set of actions, and the configuration metadata. The method may further include processing, by the implementation framework, a set of messages received from the IoT device based on the process flow, the set of custom actions, and a set of pre-built actions.

In one embodiment, a system for implementing a software application for an IoT device is disclosed. In one example, the system may include an IoT implementation framework, which may further at least one processor and a memory communicatively coupled to the at least one processor. The memory may store processor-executable instructions, which, on execution, may cause the processor to define a set of events and a set of actions for the IT implementation based on a process flow and configuration metadata. The processor-executable instructions, on execution, may further cause the processor to create a set of custom actions, for the IT implementation, based on the set of events, the set of actions, and the configuration metadata. The processor-executable instructions, on execution, may further cause the processor to process a set of messages received from the IoT device based on the process flow, the set of custom actions, and a set of pre-built actions.

In one embodiment, a non-transitory computer-readable medium storing computer-executable instructions for implementing a software application for an IoT device is disclosed. In one example, the stored instructions, when executed by a processor, may cause the processor to perform operations including defining a set of events and a set of actions for the IT implementation based on a process flow and configuration metadata. The operations may further include creating a set of custom actions, for the IT implementation, based on the set of events, the set of actions, and the configuration metadata. The operations may further include processing a set of messages received from the IoT device based on the process flow, the set of custom actions, and a set of pre-built actions.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for implementing Internet of Things (IoT) applications in accordance with some embodiments of the present disclosure.

FIG. 2 is a functional block diagram of an exemplary IoT implementation framework, implemented by the system of FIG. 1, in accordance with some embodiments of the present disclosure.

FIG. 3 is a flow diagram of an exemplary process for implementing IoT applications in accordance with some embodiments of the present disclosure.

FIG. 4 is a flow diagram of a detailed exemplary process for implementing IoT applications through an IoT implementation framework, in accordance with some embodiments of the present disclosure.

FIG. 5 is a block diagram of a detailed exemplary system for implementing IoT applications in accordance with some embodiments of the present disclosure.

FIG. 6 is a detailed block diagram of an exemplary IoT implementation framework in accordance with some embodiments of the present disclosure.

FIG. 7 is a process flow between components of the IoT implementation framework of FIG. 6, in accordance with some embodiments of the present disclosure.

FIG. 8 illustrates an exemplary message published by the IoT device, in accordance with some embodiments of the present disclosure.

FIGS. 9A and 9B are exemplary lists of pre-built actions provided by the IoT implementation framework, in accordance with some embodiments of the present disclosure.

FIG. 10 illustrates an exemplary event message generated by various components of the IoT implementation framework, in accordance with some embodiments of the present disclosure.

FIG. 11 illustrates an exemplary organization of configuration metadata and transaction metadata, in accordance with some embodiments of the present disclosure.

FIG. 12 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

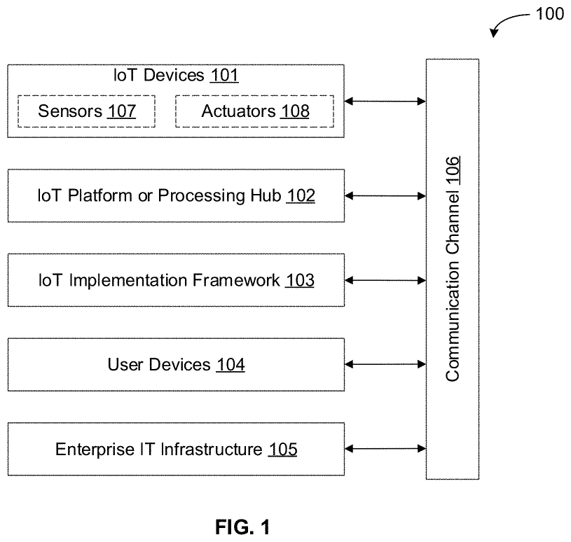

Referring now to FIG. 1, an exemplary system 100 for implementing Internet of Things (IoT) applications is illustrated in accordance with some embodiments of the present disclosure. The system 100 may include one or more IoT devices 101, an IoT platform or processing hub 102, an IoT implementation framework 103, one or more user devices 104, and an enterprise IT infrastructure 105 in communication with each other over a communication channel 106. The IoT devices 101 may include, but may not be limited to, sensors 107 and actuators 108. The sensors 107 detect any change in the ambient environment based on which the actuators 108 may trigger an appropriate response. The IoT devices 101 may be administered via the IoT platform or processing hub 102. For example, the data captured by the sensors 107 may be sent to the IoT platform 102 for subsequent processing. Further, for example, the actuators 108 may receive instructions or processed data from the IoT platform 102 for triggering the appropriate response. It should be noted that the IoT devices 101 may send or receive data from the IoT platform 102 over the communication channel 106 either directly or via an intermediary gateway.

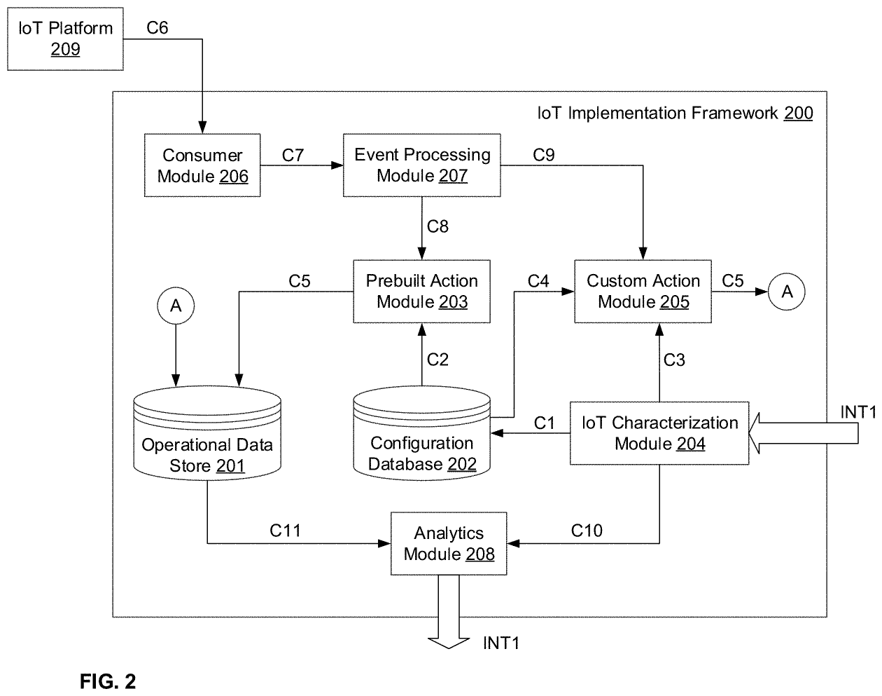

The IoT implementation framework 103 may provide for development, deployment, and implementation of software applications for IoT devices (i.e., IoT applications), in accordance with some embodiments of the present disclosure. As will be described in greater detail in conjunction with FIGS. 2-11, the IoT implementation framework 103 may define a set of events and a set of actions for the IT implementation based on a process flow and configuration metadata; create a set of custom actions, for the IT implementation, based on the set of events, the set of actions, and the configuration metadata; and process a set of messages received from the IoT device based on the process flow, the set of custom actions, and a set of pre-built actions.

The one or more user devices 104 may enable the users (e.g., developers, administrators, etc.) to interact with the system 100. For example, the administrators may administer the one or more IoT devices 101 through the IoT platform 102. Similarly, the developers may implement IoT applications on the IoT through the IoT implementation framework 103. Additionally, the IoT platform 102 and/or the IoT implementation framework 103 may itself be built on the enterprise IT infrastructure 105.

The communication channel 106 may be any wired or wireless communication channel based on different communication technologies. For example, the communication channel may include, but may not be limited to, a direct interconnection, local area network (LAN), wide area network (WAN), cellular network (e.g., code-division multiple access (CDMA), high-speed packet access (HSPA+), global system for mobile communications (GSM), long-term evolution (LTE), WiMax, etc.), wireless network (e.g., using Wireless Application Protocol, IEEE 802.n/b/g/n/x, Bluetooth, Zigbee, etc.), and the Internet.

Referring now to FIG. 2, a functional block diagram of the IoT implementation framework 200, analogous to the IoT implementation framework 103 of FIG. 1, is illustrated, in accordance with some embodiments of the present disclosure. The IoT implementation framework 200 may include various modules that perform various functions so as to facilitate implementation of IoT applications. In some embodiments, the IoT implementation framework 200 may include an operational data store (ODS) 201, a configuration database 202, a prebuilt action module 203, an IoT characterization module 204, a custom action module 205, a consumer module 206, an event processing module 207, and an analytics module 208. As will be appreciated by those skilled in the art, all such aforementioned modules and the database 201-208 may be represented as a single module or a combination of different modules. Moreover, as will be appreciated by those skilled in the art, each of the modules and the database 201-208 may reside, in whole or in parts, on one device or multiple devices in communication with each other.

The ODS 201 may be configured to store the transaction metadata for the IoT implementation for each of the interfaces. In some embodiments, the transaction metadata may include, but may not be limited to, transaction identification, application name, application version, device identification, event identification, event name, action name, present state, date, time, status code, and status message for each of the IoT devices and for actions and events for a given IoT application implementation on each of the IoT devices.

The configuration database 202 may be configured to store the configuration metadata for the IoT application. In some embodiments, the configuration metadata may include, but may not be limited to, application name, application version, interface name, interface identification, source protocol, target protocol, end point, security scheme, credentials, process flow, event name, event identification, action name, debug level, correlation flag, persistency flag, and priority.

The prebuilt action module 203 may be configured to create a number of actions or API's that may perform generic tasks. As will be appreciated, the generic tasks may be re-used across the interfaces in an IoT application implementation. For example, the generic tasks may include, but may not be limited to, initialization, caching, routing, transformation, protocol bridging, reporting, logging, error handling etc. When a prebuilt action finishes its tasks, it may create an event message and may push it to an event queue (EVENT.Q). As will be appreciated, the EVENT.Q may be a container that may store all the event messages. It should be noted that, in some embodiments, the event message may abide to the common event message (CEM) format. The prebuilt action module 203 may receive the configuration metadata for each of the event message from the configuration database 202 via a connection C2. Further, each of the prebuilt actions may be updated in the ODS 201 with the latest status and other details based on the ‘debug level’ configuration metadata. The prebuilt action module 203 may send the ‘debug level’ configuration metadata to the ODS 201 via a connection C2.

The IoT characterization module 204 may be configured to define the events and actions for the IoT application implementation by providing details about the process flow along with the configuration metadata. The IoT characterization module 204 may receive details about the process flow and the configuration metadata from a user (e.g., developer) through a user interface. It should be noted that, in some embodiments, the user interface may be a graphic user interface (GUI) rendered over a web browser. In such embodiments, the IoT characterization module 204 may be also referred to as ‘web GUI’ or ‘web console’. The user interface may receive user inputs via an I/O interface INT1. Further, the configuration database 202 may be updated based on the events and actions defined by the IoT characterization module 204. The IoT characterization module 204 may send the configuration metadata to the configuration database 202 via a connection C1.

The custom action module 205 may be configured to create a number of custom actions or custom API's that may perform specific tasks. As will be appreciated, the specific tasks may be based on specific business logic and the requirements of the IoT application implementation. When a custom action finishes its tasks, it may create an event message and may push it to the event queue (EVENT.Q). As stated above, in some embodiments, the event message may abide to the CEM format. The custom action module 205 may receive the definitions of the events and actions from the IoT characterization module 204 via a connection C3. Additionally, the custom action module 205 may receive the configuration metadata for each of the event message from the configuration database 202 via a connection C4. Further, each of the custom actions may be updated in the ODS 201 with the latest status and other details based on the ‘debug level’ configuration metadata. The custom action module 205 may send the ‘debug level’ configuration metadata to the ODS 201 via a connection C5.

The consumer module 206 may be configured to receive messages published by various IoT devices from an IoT platform 209, analogous to the IoT platform 102 of FIG. 1, via a connection C6. As stated above, the IoT platform 209 may be connected to the IoT devices either directly or via a gateway server and may receive messages published by such connected IoT devices. The IoT devices may publish messages with a topic and other details. For example, the published messages may include all the details with respect to the device, location, address, etc. along with the payload. Further, the consumer module 206 may consume the published messages and may push the message to a generic queue named consumer queue (CON.Q).

The event processing module 207 may be configured to receive message from various queues. As stated above, in some embodiments, the various queues may include consumer queue (CON.Q) and the event queue (EVENT.Q). The event processing module 207 may receive consumer queue (CON.Q) via a connection C7. The event queue (EVENT.Q) may include event messages in the CEM format. Further, the event processing module 207 may be configured to process the messages in the queue by calling appropriate prebuilt actions and the custom actions. The event processing module 207 may send the data to the prebuilt action module 203 via a connection C8 and to the custom action module 205 via a connection C9 for performing the respective events and actions. It should be noted that, in some embodiments, the event processing module 207 may process the messages by retrieving the configuration metadata from the configuration database 202 based on the consumer queue message and by keeping the retrieved details in the in-memory cache.

The analytics module 208 may be configured to generate a deep insight and predictive analytics on the data stored into the ODS 201 based on the input from the IoT characterization module 204. The analytics module 208 may receive the data from the IoT characterization module 204 via a connection C10 and from the ODS 201 via a connection C11. Further, the analytics module 208 may provide the output to the user via an I/O interface INT2.

As will be appreciated, each of the interfaces, INT1-INT2, may acquire data from or transfer data to one or more I/O devices (e.g., display, printer, keyboard, or the like) using standard wired or wireless data connections means. For example, each of the interfaces, INT1-INT2, may employ one or more communication protocols including, but not limited to, IEEE-1394, near field communication (NFC), FireWire, Camera Link®, GigE, serial bus, universal serial bus (USB) (e.g., USB 2.0, USB 3.0, or the like), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, and cellular (e.g., code-division multiple access (CDMA), high-speed packet access (HSPA+), global system for mobile communications (GSM), long-term evolution (LTE), WiMax, or the like).

Further, as will be appreciated, each of the connections, C1-C12, may acquire or transfer data from one module, database, or platform 201-209 to the other module, database, or platform 201-209 using standard wired or wireless data connections means. For example, each of the connections, C1-C11, may employ one or more connection protocols including, but not limited to, serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathlnterconnect, InfiniBand, and PCIe.

It should be noted that the IoT implementation framework 200 may be implemented in programmable hardware devices such as programmable gate arrays, programmable array logic, programmable logic devices, or the like. Alternatively, the IoT implementation framework 200 may be implemented in software for execution by various types of processors. An identified module of executable code may, for instance, include one or more physical or logical blocks of computer instructions which may, for instance, be organized as an object, procedure, function, or other construct. Nevertheless, the executables of an identified module need not be physically located together, but may include disparate instructions stored in different locations which, when joined logically together, comprise the module and achieve the stated purpose of the module. Indeed, a module of executable code may be a single instruction, or many instructions, and may even be distributed over several different code segments, among different applications, and across several memory devices.

As will be appreciated by one skilled in the art, a variety of processes may be employed for implementing IoT applications. For example, the exemplary system 100 and the associated IoT implementation framework 200 may implement IoT applications by the processes discussed herein. In particular, as will be appreciated by those of ordinary skill in the art, control logic and/or automated routines for performing the techniques and steps described herein may be implemented by the system 100 and the associated IoT implementation framework 200, either by hardware, software, or combinations of hardware and software. For example, suitable code may be accessed and executed by the one or more processors on the system 100 or the associated IoT implementation framework 200 to perform some or all of the techniques described herein. Similarly, application specific integrated circuits (ASICs) configured to perform some or all of the processes described herein may be included in the one or more processors on the system 100.

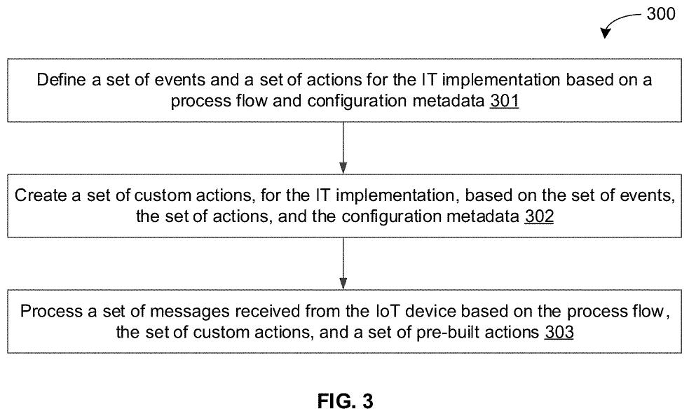

For example, referring now to FIG. 3, exemplary control logic 300 for implementing IoT applications via a system, such as system 100, or an IoT implementation framework, such as IoT implementation framework 200, is depicted via a flowchart in accordance with some embodiments of the present disclosure. As illustrated in the flowchart, the control logic 300 may include the steps of defining a set of events and a set of actions for the IT implementation based on a process flow and configuration metadata at step 301, creating a set of custom actions, for the IT implementation, based on the set of events, the set of actions, and the configuration metadata at step 302, and processing a set of messages received from the IoT device based on the process flow, the set of custom actions, and a set of pre-built actions at step 303.

In some embodiments, the control logic 300 may further include the step of storing transaction metadata for each of a plurality of interfaces and for each of a plurality of IoT devices in an operational data store (ODS). It should be noted that, for each of the plurality of IoT devices, the transaction metadata may include at least one of a transaction ID, an application name, an application version, a device ID of the IoT device, an event ID, a location of the IoT device, an event name, an action name, a present state, a date, a time, a status code, a status message of the IoT device, a plurality of events for the IT implementation, or a plurality of actions for the IT implementation. In some embodiments, the control logic 300 may further include the step of generating insights by analyzing the transaction metadata.

Additionally, in some embodiments, the control logic 300 may further include the step of storing the configuration metadata for each of a plurality of IoT applications in a configuration database. It should be noted that the configuration metadata may include at least one of an application name, an application version, an interface name, an interface ID, a source protocol, a target protocol, an end point, a security scheme, a plurality of credentials, a process flow, an event name, an event ID, an action name, a debug level, a correlation flag, a persistency flag, or a priority.

Further, in some embodiments, the control logic 300 may further include the step of creating a plurality of pre-built actions for a plurality of generic tasks to be employed across a plurality of interfaces in the IT implementation for the IoT device. It should be noted that, upon completion of a corresponding generic task, each pre-built action may be configured to create an event message based on the configuration metadata and to update transaction metadata. Moreover, in some embodiments, the plurality of custom action may correspond to specific business logic and requirement of the IT implementation. It should be noted that, upon completion of a corresponding specific task, each custom action may be configured to create an event message based on the configuration metadata and to update transaction metadata.

In some embodiments, each of the set of messages may include at least one of a topic, a location of the IoT device, or an address of the IoT device. Further, in some embodiments, processing at step 303 may include processing the set of messages as per queue by calling appropriate pre-built actions from the set of pre-built actions and appropriate custom actions from the set of custom actions.

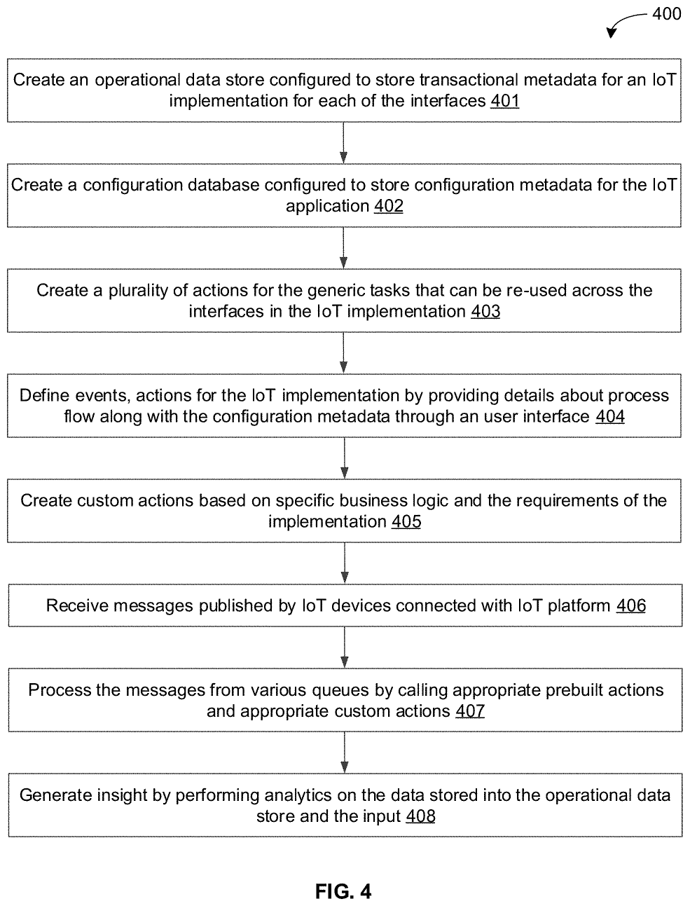

Referring now to FIG. 4, exemplary control logic 400 for implementing IoT applications through an IoT implementation framework is depicted in greater detail via a flowchart in accordance with some embodiments of the present disclosure. As illustrated in the flowchart, at step 401, the control logic 400 may create an operational data store (ODS) configured to store the transaction metadata for the implementation of the IoT application and for each of the interfaces. The transaction metadata may include, but may not be limited to, transaction identification, application name, application version, device identification, event identification, event name, action name, present state, date, time, status code, and status message of various IoT devices and their actions and events in the IoT application implementation.

Additionally, at step 402, the control logic 400 may create a configuration database configured to store the configuration metadata for the IoT application. The configuration metadata may include, but may not be limited to, application name, application version, interface name, interface identification, source protocol, target protocol, end point, security scheme, credentials, process flow, event name, event identification, action name, debug level, correlation flag, persistency flag, and priority.

Further, at step 403, the control logic 400 may create a number of actions or API's for performing the generic tasks, which may be re-used across the interfaces in the implementation of the IoT application. When a pre-built action finishes its tasks, it may create an event message abiding to the common event message (CEM) format and push it to an event queue (EVENT.Q). The configuration metadata for each of the event message may be received from the configuration database. Further, each of the prebuilt-action may be updated in the ODS with the latest status and other details based on the ‘debug level’ configuration metadata.

At step 404, the control logic 400 may define the events and actions for the implementation of IoT application by providing details about the process flow along with the configuration metadata. The details and the configuration metadata may be received through a user interface. Based on the events and actions, the control logic 400 may update the configuration database.

At step 405, the control logic 400 may create custom actions or API's based on specific business logic and the requirements for the implementation of the IoT application. In particular, the control logic 400 may create custom actions or API's based on the definitions of the events and actions and the configuration metadata for each of the event message. When the custom action finishes its tasks, it may create an event message abiding to the CEM format and may push it to an event queue (EVENT.Q). Each of the custom action may be updated in the ODS with the latest status and other details based on the ‘debug level’ configuration metadata.

At step 406, the control logic 400 may receive the messages published by the IoT devices connected with the IOT platform. As stated above, the published messages may include all the details with respect to the device, location, address etc. along with the payload. The control logic 400 may consume the published messages and may push the message to a generic queue named consumer queue (CON.Q).

At step 407, the control logic 400 may receive and process the messages from the various queues (i.e., CON.Q and EVENT.Q) by calling appropriate prebuilt actions and the custom actions. The prebuilt actions and the custom actions may perform respective events and actions. Further, the control logic 400 may process the messages by retrieving the configuration metadata from the configuration database based on the consumer queue message and by keeping the retrieved details in the in-memory cache.

At step 408, the control logic 400 may generate a deep insight and predictive analytics with respect to the data stored into the ODS and based on the user input. The control logic 400 may then provide the result to the user via the user interface.

As will be appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

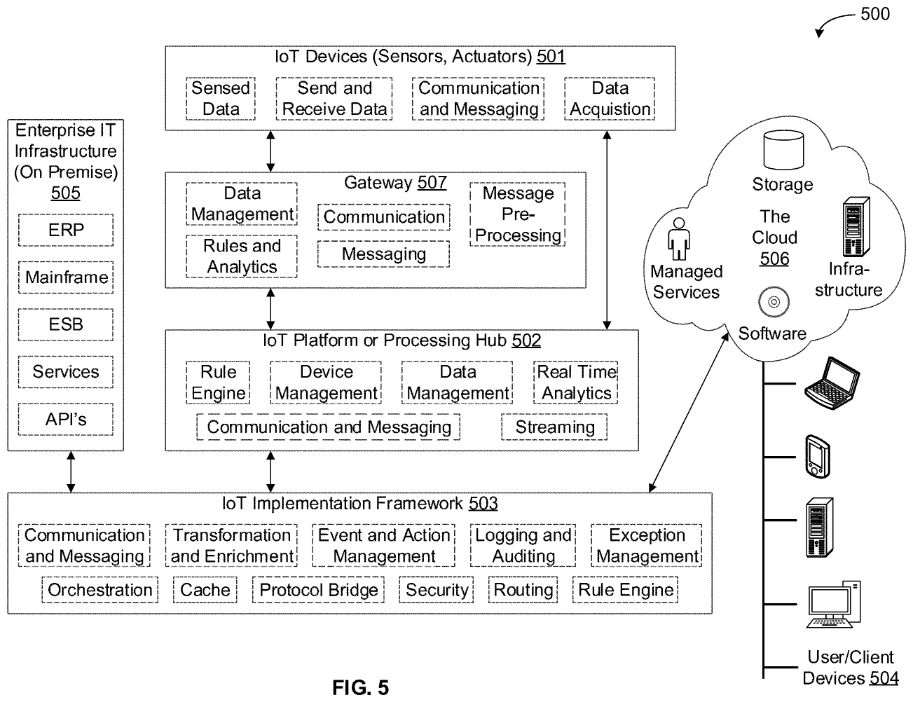

Referring now to FIGS. 5-11, an exemplary implementation scenario for developing and implementing an IoT application through a system, such as system 100 or an IoT implementation framework, such as IoT implementation framework 200, is illustrated, in accordance with some embodiments of the present disclosure. FIG. 5 illustrates a detailed exemplary system 500, analogous to system 100 of FIG. 1, for implementing IoT applications in accordance with some embodiments of the present disclosure. As will be appreciated, the system may include IoT devices 501 in communication with an IoT platform or a processing hub 502 either directly or via a gateway server 507. Each of the IoT devices 501 may include sensors, actuators, electronics, software, and so forth. Each of the IoT devices 501 may sense data, perform data acquisition, send and receive data, perform communication and messaging, and so forth. Additionally, the IoT platform 502 may perform data management, device management, communication and messaging, streaming, real-time analytics, data processing using rules engine, and so forth. Further, the gateway 507 may perform data management, communication, messaging, message pre-processing, analytics, application of rules, and so forth.

The IoT platform 502 may be in communication with an IoT implementation framework 503. In particular, the IoT platform 502 may use the IoT implementation framework 503 for any IoT information technology (IT) implementation (e.g., IoT application implementation). Thus, once the IoT platform 502 receives the data, the IoT implementation framework 503 may acquire the data and do the end to end processing with the help of all of its components. For example, the IoT implementation framework 503 may perform communication and messaging, orchestration, caching, security implementation, data processing using rules engine, data transformation and enrichment, routing, event and action management, logging and auditing, exception management, protocol bridging, and so forth.

The IoT implementation framework 503 may be placed between the IoT platform 502 and other applications (cloud, legacy, etc.). Further, the IoT implementation framework 503 may be placed on cloud or on premises or both based on the organization topology. As will be appreciated, in some embodiments, the IoT implementation framework 503 may be in communication with one or more user devices 504 over the cloud 506. The user devices may include any processor based devices including, but not limited to, computer, desktop, laptop, notebook, netbook, smart phone, hand held computing device, server, and so forth. In such embodiments, the cloud 506 may further provide for various managed services, storage, software, infrastructure, and so forth for the IoT implementation framework 503. Further, in some embodiments, the IoT implementation framework 503 may be in communication with an enterprise IT infrastructure 505 on premise. In such embodiments, the enterprise IT infrastructure 505 may provide for enterprise resource planning (ERP) software, mainframe computers, various IT services, application programming interfaces (API's), enterprise service bus (ESB), and so forth for the IoT implementation framework 503.

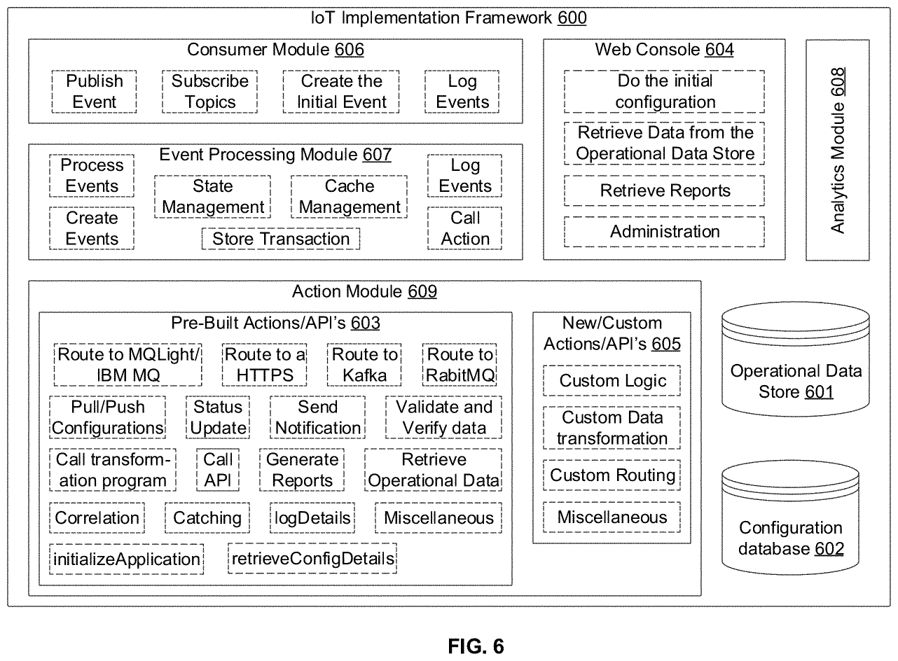

Referring now to FIG. 6, a block diagram of the IoT implementation framework 600, analogous to the IoT implementation framework 503 of FIG. 5, is illustrated, in accordance with some embodiments of the present disclosure. In some embodiments, the IoT implementation framework 600 may include an operational data store (ODS) 601, a configuration database 602, an action module 609, a web console 604, a consumer module 606, an event processing module 607, and an analytics module 608. The action module 609 may further include prebuilt action module 603 and custom action module 604.

As discussed above, the ODS 601 may be configured to store the transaction metadata for the IoT implementation for each of the interfaces. Similarly, the configuration database 602 may be configured to store the configuration metadata for the IoT application. The prebuilt action module 603 may be configured to create a number of pre-built actions or API's that may perform generic tasks. For example, the pre-built action module 603 may create actions or API's for routing (e.g., route to IBM MQLight, route to IBM MQ, route to a HTTPS end point, route to Kafka, route to RabitMQ, or the like), calling functions (e.g., call a transformation program, call an API, or the like), processing (e.g., initialize a transaction, validate data, correlate transaction, manage cache, or the like), operation (e.g., pull configuration, push configuration, update transaction status, log details, send notification, retrieve configuration details, generate reports, get analytics, retrieve operational data store, or the like), and so forth.

The web console 604 (analogous to the IoT characterization module 204) may be configured to define the events and actions for the IoT application implementation by providing details about the process flow along with the configuration metadata. Additionally, the web console 604 may perform the initial configuration, retrieve data from the ODS 601, retrieve reports, and perform administration. The custom action module 605 may be configured to create a number of new or custom actions or API's that may perform specific tasks. In particular, the custom action module 605 may create custom actions or API's for custom logic, custom data transformation, custom routing, and so forth.

The consumer module 606 may be configured to receive messages published by various IoT devices from the IoT platform. Additionally, the consumer module 606 may publish events, subscribe topics, create initial events, log events, and so forth. The event processing module 607 may be configured to receive and process messages from various queues by calling appropriate prebuilt actions and the custom actions. Additionally, the event processing module 607 may process events, create events, perform state management, perform cache management, store transaction, log events, call actions, and so forth. The analytics module 608 may be configured to generate deep insight by performing analytics on the transaction metadata stored in the ODS 601. It should be noted that the analytics may be performed based on the user input received through the web console 604.

As will be appreciated, the IoT implementation framework 600 may facilitate development and implementation of the IoT application. In some embodiments, there may be one or more pre-requisites for the development and implementation of the IoT application. For example, the architect, designers, or developers should a) know the end to end requirement of the IoT application to be developed and implemented, b) make their design artefacts, c) list down the event and action details with their functionality, d) be ready with non-functional requirement (NFR) details such as protocol, security etc., e) configure the application or interface metadata details into various tables, f) get the know how about the pre-built Actions/Services/API's, and so forth.

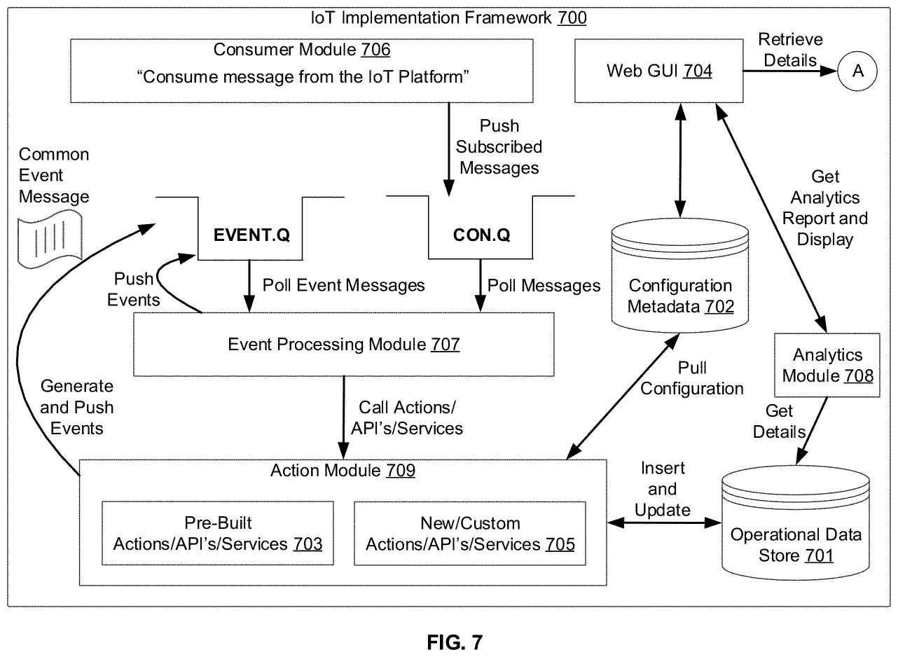

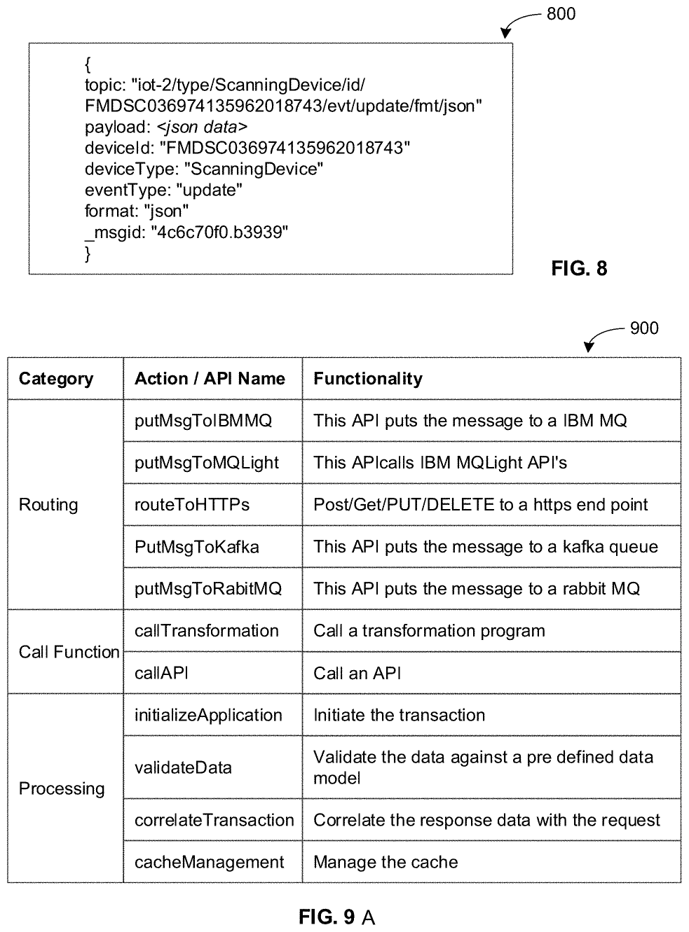

Referring now to FIG. 7, a process flow between components 701-708 of the IoT implementation framework 700 is illustrated, in accordance with some embodiments of the present disclosure. As discussed above, the IoT device may connect with the IoT platform (e.g., placed on cloud) directly or via a gateway server and publishes messages with a topic with other details. The published messages may include the details with respect to the device, location, address etc. along with the payload. Referring now to FIG. 8, an exemplary message 800 published by the IoT device is illustrated, in accordance with some embodiments of the present disclosure. Referring back to FIG. 7, the IoT implementation framework 700 may consume the message from the IoT platform via the consumer module 706. The consumer module 706 may then push the consumed messages to a generic queue named consumer queue (CON.Q). It should be noted that, for the purpose of queuing, any technology (e.g., IBM MQ, Kafka, Rabit MQ, etc.) may be employed.

The event processing module 707 may listen messages from various queues. In particular, the event processing module 707 may listen messages from consumer queue (CON.Q) containing the messages from IoT devices, and the event queue (EVENT.Q) containing event messages with common event message (CEM) format. First, the event processing module 707 may pick the message from the ‘CON.Q’ and read the message. The event processing module 707 may then retrieve the configuration metadata from the configuration database 702 using topic as primary key by calling a pre-built action “retriveConfigDetails’. The event processing module 707 may keep the retrieved details in the in-memory cache. The event processing module 707 may further call another pre-built action ‘logDetails’ which may store the retrieved details into the operational data store (ODS) 701.

Further, the event processing module 707 may call pre-built action ‘initializeApplication’ which may create an event message with CEM format. The created event message may include the action to be called which may be application specific. The event processing module 707 may then put the message to the EVENT.Q with a topic ‘GenericEvent’. As will be appreciated, the EVENT.Q may be dedicated to store the event messages, which may be polled continuously by the event processing module 707. In particular, the event processing module 707 may read the event message and call different pre-built or custom actions.

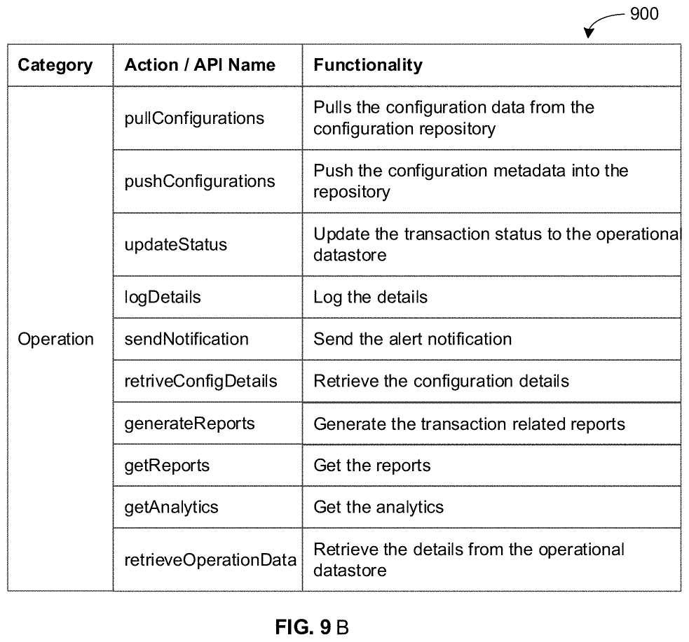

The IoT implementation framework 700 may provide for actions that may perform certain tasks via the action module 709. These actions may also be referred to as API's or services. In particular, the action module 709 may provide for at least two types of actions: pre-built actions for generic tasks and custom actions for specific tasks. Referring now to FIGS. 9A and 9B, exemplary lists 900 of pre-built actions provided by the IoT implementation framework 700 is illustrated, in accordance with some embodiments of the present disclosure. As stated above, these pre-built actions may perform certain generic tasks and may be re-used across the interfaces on need basis. A number of generic tasks may be performed by these pre-built actions or API's including, but not limited to, initialization, caching, routing, calling, correlation, transformation, protocol bridging, reporting, logging, error handling, report generation, analytics, retrieval, storage, and validation. Referring back to FIG. 7, the action module 709 may also provide for development of some of the custom actions based on the requirement.

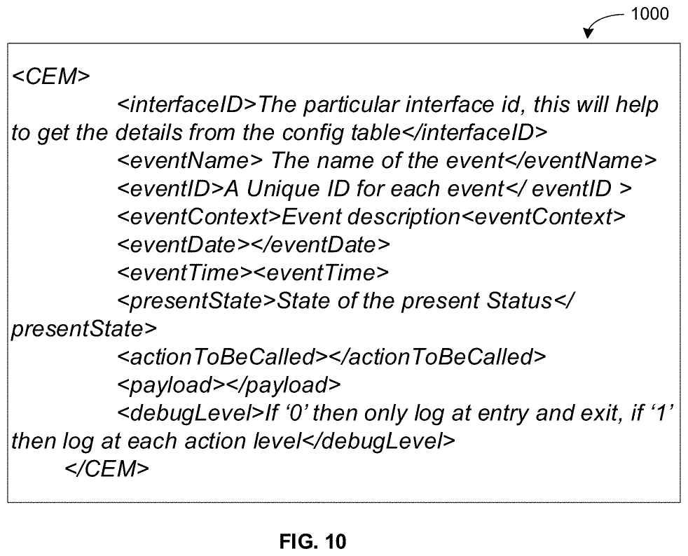

It should be noted that, each of the actions may be able to update the ODS 701 with the latest status and other details based on the ‘debug level’ configuration metadata. For example, if the ‘debug level’ is set as ‘0’, each of actions in the process flow may capture only the entry and exit logging. However, for example, if the ‘debug level’ is set as 1, each of the actions may capture the details into the ODS 701 along with its latest status. Once an action may finish its tasks, the action may create an even message abiding to the CEM format and push it to the event queue (EVENT.Q). As will be appreciated, the common event message may be a canonical event message to be generated by various components or modules, such as, pre-build actions module 703 or custom actions module 705. Referring now to FIG. 10, an exemplary event message in CEM format generated by various components of the IoT implementation framework 700 is illustrated, in accordance with some embodiments of the present disclosure.

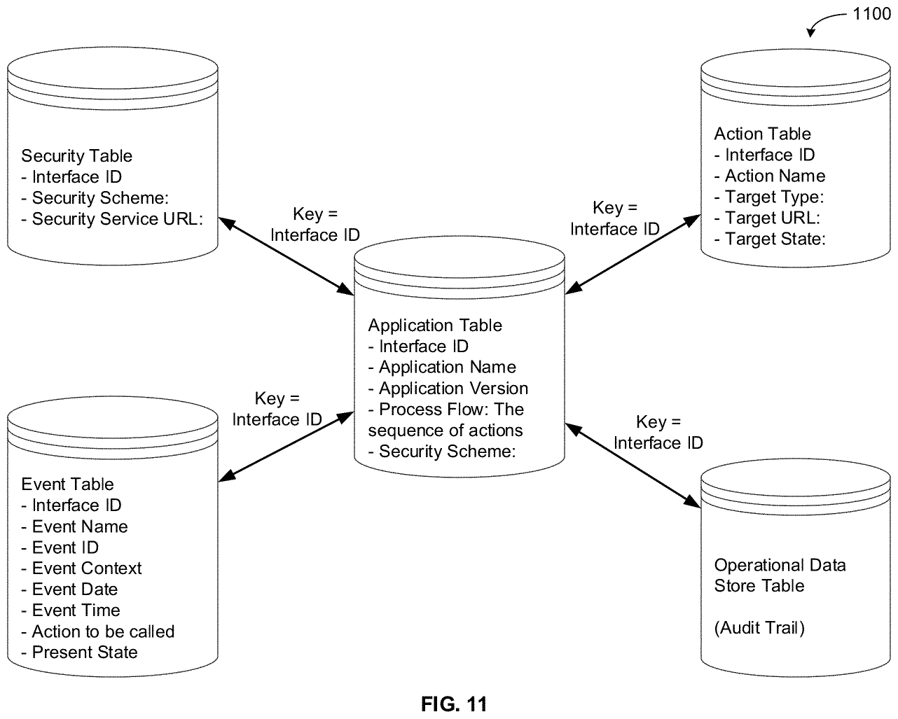

In some embodiments, the IoT implementation framework 700 may employ a relative database management system (RDBMS) so as to provide for storage and organization of transaction metadata and configuration metadata. Thus, the operational data store 701 and the configuration database 702 may be implemented as RDBMS. Referring now to FIG. 11, an exemplary organization of configuration metadata and transaction metadata is illustrated, in accordance with some embodiments of the present disclosure. As illustrated, multiple RDBMS tables (e.g., application table, action table, security table, event table, etc.) may be employed to store and organize the configuration metadata. Similarly, one or more RDBMS tables (e.g., operation data store table, etc.) may be employed to store and organize the transaction metadata. It should be noted that, in some embodiments, the creation of multiple tables may be a one-time activity by the developers or the designers. In the run time, the modules (e.g., even processing module 707) may retrieve the details once from the tables and keep the same in the in-memory cache.

In some embodiments, the IoT implementation framework 700 may be implemented using blockchain technology. In such embodiments, the IoT implementation framework 700 may store each of the transactions into a blockchain using a shared ledger. In particular, the transaction metadata managed by the RDMS may be replaced by a distributed ledger technology.

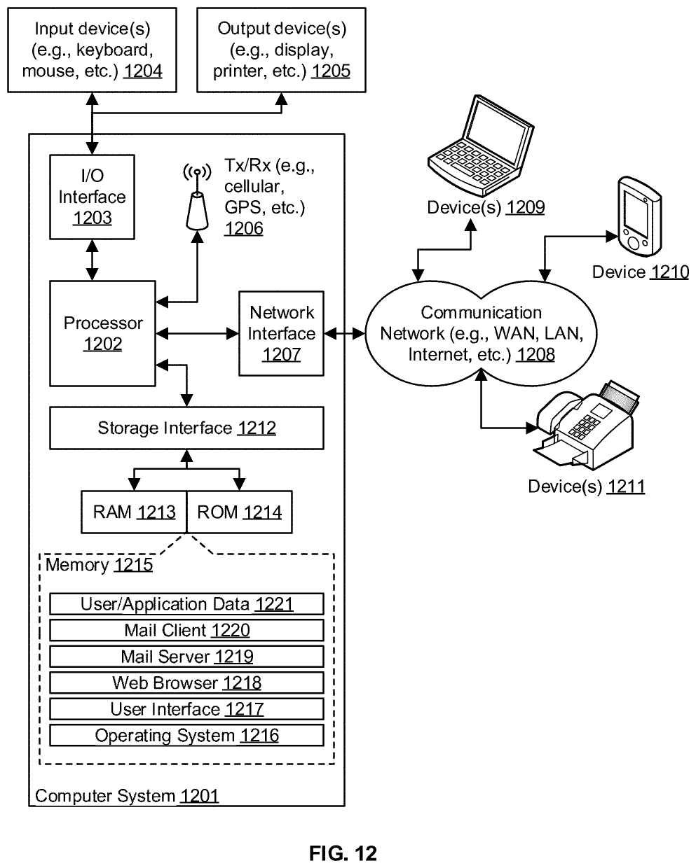

The disclosed methods and systems may be implemented on a conventional or a general-purpose computer system, such as a personal computer (PC) or server computer. Referring now to FIG. 12, a block diagram of an exemplary computer system 1201 for implementing embodiments consistent with the present disclosure is illustrated. Variations of computer system 1201 may be used for implementing system 100 and associated IoT implementation framework 200 for implementing IoT applications. Computer system 1201 may include a central processing unit (“CPU” or “processor”) 1202. Processor 1202 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 1202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1202 may be disposed in communication with one or more input/output (I/O) devices via I/O interface 1203. The I/O interface 1203 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 1203, the computer system 1201 may communicate with one or more I/O devices. For example, the input device 1204 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 1205 may be a printer, fax machine, video display (e.g., cathode ray tube (CRT), liquid crystal display (LCD), light-emitting diode (LED), plasma, or the like), audio speaker, etc. In some embodiments, a transceiver 1206 may be disposed in connection with the processor 1202. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 1202 may be disposed in communication with a communication network 1208 via a network interface 1207. The network interface 1207 may communicate with the communication network 1208. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1208 may include, without limitation, a direct interconnection, local area network (LAN), wide area network (WAN), wireless network (e.g., using Wireless Application Protocol), the Internet, etc. Using the network interface 1207 and the communication network 1208, the computer system 1201 may communicate with devices 1209, 1210, and 1211. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 1201 may itself embody one or more of these devices.

In some embodiments, the processor 1202 may be disposed in communication with one or more memory devices (e.g., RAM 1213, ROM 1214, etc.) via a storage interface 1212. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathlnterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 1216, user interface application 1217, web browser 1218, mail server 1219, mail client 1220, user/application data 1221 (e.g., any data variables or data records discussed in this disclosure), etc. The operating system 1216 may facilitate resource management and operation of the computer system 1201. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 1217 may facilitate display, execution, interaction, manipulation, or operation of program components through textual or graphical facilities. For example, user interfaces may provide computer interaction interface elements on a display system operatively connected to the computer system 1201, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 1201 may implement a web browser 1218 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 1201 may implement a mail server 1219 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 1201 may implement a mail client 1220 stored program component. The mail client may be a mail viewing application, such as Apple Mail, Microsoft Entourage, Microsoft Outlook, Mozilla Thunderbird, etc.

In some embodiments, computer system 1201 may store user/application data 1221, such as the data, variables, records, etc. (e.g., configuration metadata, transaction metadata, pre-built actions, custom actions, published messages, event messages, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above provide for a configurable, portable, platform independent, and technology agnostic framework for efficient, effective, and robust information technology (IT) implementation on IoT (e.g., implementation of IoT applications). The IoT implementation framework described in the various embodiments discussed above may reduce design and development effort for any IoT application by eliminating or limiting repetitive works or by eliminating or limiting design and development of redundant components. For example, the IoT implementation framework may save up to 30-50% of design and development effort for any IoT implementation from IT perspective. This may enable the organization to adopt IoT faster and with better quality while providing flexibility and agility throughout the project life cycle and while reducing the dependency on the specialized developers.

By way of an example, the IoT implementation framework may enable implementation of IoT applications by creating a number of pre-built actions and a number of custom actions. As will be appreciated, the set of pre-built actions (i.e., API's or services or functions) may be part of the framework to perform certain generic tasks or activities. The pre-built actions may be re-used for most of the IoT application implementation, thereby limiting the application and module redundancy. In certain scenarios, the pre-built actions or API's may be independently monetized through ‘as a service model’. Further, the custom actions or API's may be created based on the specific business logic and the requirements of the IoT application implementation, and may perform specific tasks. Further, a consumer module may consume the messages published in the IoT platform, and may push such messages to a consumer queue (CON.Q), which is processed by the event processing module by calling appropriate prebuilt actions and the custom actions by retrieving the configuration metadata from the configuration database. All the events may be processed by an event driven architecture.

Thus, for any new IoT application development and implementation project, the developers may directly start the development process rather than starting afresh from architecture and design process. As a part of new development, only the custom services or functions (i.e., actions or API's) may be developed. The processing may happen through metadata configured in the configuration database.

It should be noted that the architecture pattern for the IoT implementation framework may be a mix of service oriented architecture (SOA) and micro-services. The micro-service may enable re-usable services. The components may be stateless and loosely coupled. Additionally, the IoT implementation framework may support all the standard communication and transportation protocols. All the configuration may be done via a simplified admin console along with command line interface (CLI) option. The admin console may also be used for any administrative and reporting job. The framework may support to build or develop custom actions with a pre-defined standard. The common event messages (CEM) format may be employed to standardize the interface with simpler approach. Further, the framework may support all the integration pattern starting from ‘fire and forget’, ‘synchronous request—reply’, ‘file processing’, ‘batch mode’, ‘online’, and so forth. Moreover, the framework may support different interface pattern like simple object access protocol (SOAP), representational state transfer (REST), remote method invocation (RMI), or any other proprietary protocol. Further, as will be appreciated by those skilled in the art, the IoT implementation framework described in the various embodiments discussed above is easy to migrate into different platform and provides for a one stop shop for configuration management, administration, and reporting. Moreover, the IoT implementation framework may be integrated with blockchain, analytics engine, and so forth. For example, the analytics engine may be used for data insights. In particular, the IoT implementation framework in conjunction with the analytics engine may generate a deep insight and predictive analytics based on the transaction data.

The specification has described method, system, and framework for implementing IoT applications. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of implementing a software application for an Internet of things (IoT) device, the method comprising:
defining, by an IoT implementation framework, a set of events and a set of actions for the IT implementation based on a process flow and configuration metadata;
creating, by the implementation framework, a set of custom actions, for the IT implementation, based on the set of events, the set of actions, and the configuration metadata; and
processing, by the implementation framework, a set of messages received from the IoT device based on the process flow, the set of custom actions, and a set of pre-built actions.

2. The method of claim 1, further comprising storing transaction metadata for each of a plurality of interfaces and for each of a plurality of IoT devices in an operational data store, wherein, for each of the plurality of IoT devices, the transaction metadata comprises at least one of a transaction ID, an application name, an application version, a device ID of the IoT device, an event ID, a location of the IoT device, an event name, an action name, a present state, a date, a time, a status code, a status message of the IoT device, a plurality of events for the IT implementation, or a plurality of actions for the IT implementation.

3. The method of claim 2, further comprising generating insights by analyzing the transaction metadata.

4. The method of claim 1, further comprising storing the configuration metadata for each of a plurality of IoT applications in a configuration database, wherein the configuration metadata comprises at least one of an application name, an application version, an interface name, an interface ID, a source protocol, a target protocol, an end point, a security scheme, a plurality of credentials, a process flow, an event name, an event ID, an action name, a debug level, a correlation flag, a persistency flag, or a priority.

5. The method of claim 1, further comprising creating a plurality of pre-built actions for a plurality of generic tasks to be employed across a plurality of interfaces in the IT implementation for the IoT device, wherein, upon completion of a corresponding generic task, each pre-built action is configured to create an event message based on the configuration metadata and to update transaction metadata.

6. The method of claim 1, wherein the plurality of custom action corresponds to specific business logic and requirement of the IT implementation, wherein, upon completion of a corresponding specific task, each custom action is configured to create an event message based on the configuration metadata and to update transaction metadata.

7. The method of claim 1, wherein each of the set of messages comprises at least one of a topic, a location of the IoT device, or an address of the IoT device.

8. The method of claim 1, wherein the processing comprises processing the set of messages as per queue by calling appropriate pre-built actions from the set of pre-built actions and appropriate custom actions from the set of custom actions.

9. A system for implementing a software application for an Internet of things (IoT) device, the system comprising:
an IoT implementation framework comprising at least one processor and a computer-readable medium storing instructions that, when executed by the at least one processor, cause the at least one processor to perform operations comprising:
defining a set of events and a set of actions for the IT implementation based on a process flow and configuration metadata;
creating a set of custom actions, for the IT implementation, based on the set of events, the set of actions, and the configuration metadata; and
processing a set of messages received from the IoT device based on the process flow, the set of custom actions, and a set of pre-built actions.

10. The system of claim 9, wherein the operations further comprise storing transaction metadata for each of a plurality of interfaces and for each of a plurality of IoT devices in an operational data store, and wherein, for each of the plurality of IoT devices, the transaction metadata comprises at least one of a transaction ID, an application name, an application version, a device ID of the IoT device, an event ID, a location of the IoT device, an event name, an action name, a present state, a date, a time, a status code, a status message of the IoT device, a plurality of events for the IT implementation, or a plurality of actions for the IT implementation.

11. The system of claim 10, wherein the operations further comprise generating insights by analyzing the transaction metadata.

12. The system of claim 9, wherein the operations further comprise storing the configuration metadata for each of a plurality of IoT applications in a configuration database, and wherein the configuration metadata comprises at least one of an application name, an application version, an interface name, an interface ID, a source protocol, a target protocol, an end point, a security scheme, a plurality of credentials, a process flow, an event name, an event ID, an action name, a debug level, a correlation flag, a persistency flag, or a priority.

13. The system of claim 9, wherein the operations further comprise creating a plurality of pre-built actions for a plurality of generic tasks to be employed across a plurality of interfaces in the IT implementation for the IoT device, and wherein, upon completion of a corresponding generic task, each pre-built action is configured to create an event message based on the configuration metadata and to update transaction metadata.

14. The system of claim 9, wherein the plurality of custom action corresponds to specific business logic and requirement of the IT implementation, and wherein, upon completion of a corresponding specific task, each custom action is configured to create an event message based on the configuration metadata and to update transaction metadata.

15. The system of claim 9, wherein each of the set of messages comprises at least one of a topic, a location of the IoT device, or an address of the IoT device.

16. The system of claim 9, wherein the processing comprises processing the set of messages as per queue by calling appropriate pre-built actions from the set of pre-built actions and appropriate custom actions from the set of custom actions.

17. A non-transitory computer-readable medium storing computer-executable instructions for implementing a software application for an Internet of things (IoT) device, the computer-executable instructions configured for:
defining a set of events and a set of actions for the IT implementation based on a process flow and configuration metadata;
creating a set of custom actions, for the IT implementation, based on the set of events, the set of actions, and the configuration metadata; and
processing a set of messages received from the IoT device based on the process flow, the set of custom actions, and a set of pre-built actions.

18. The non-transitory computer-readable medium of claim 17, wherein the computer-executable instructions are further configured for:
storing transaction metadata for each of a plurality of interfaces and for each of a plurality of IoT devices in an operational data store, wherein, for each of the plurality of IoT devices, the transaction metadata comprises at least one of a transaction ID, an application name, an application version, a device ID of the IoT device, an event ID, a location of the IoT device, an event name, an action name, a present state, a date, a time, a status code, a status message of the IoT device, a plurality of events for the IT implementation, or a plurality of actions for the IT implementation; and
storing the configuration metadata for each of a plurality of IoT applications in a configuration database, wherein the configuration metadata comprises at least one of an application name, an application version, an interface name, an interface ID, a source protocol, a target protocol, an end point, a security scheme, a plurality of credentials, a process flow, an event name, an event ID, an action name, a debug level, a correlation flag, a persistency flag, or a priority.

19. The non-transitory computer-readable medium of claim 17, wherein the computer-executable instructions are further configured for creating a plurality of pre-built actions for a plurality of generic tasks to be employed across a plurality of interfaces in the IT implementation for the IoT device, and wherein, upon completion of a corresponding generic task, each pre-built action is configured to create an event message based on the configuration metadata and to update transaction metadata.

20. The non-transitory computer-readable medium of claim 17, wherein the plurality of custom action corresponds to specific business logic and requirement of the IT implementation, and wherein, upon completion of a corresponding specific task, each custom action is configured to create an event message based on the configuration metadata and to update transaction metadata.
